(19) United States
(12) Patent Application Publication
(10) Pub. No.: US 2020/0115873 A1
(43) Pub. Date: Apr. 16, 2020

(54) WIREGUARD HAVING INTEGRATED CLEATS

(71) Applicant: Caterpillar Inc., Deerfield, IL (US)

(72) Inventors: Daniel J. Pierce, Deadwood, SD (US); Vinayak R. Ugru, Peoria, IL (US)

(73) Assignee: Caterpillar Inc., Deerfield, IL (US)

(21) Appl. No.: 16/161,385

(22) Filed: Oct. 16, 2018

(51) Int. Cl. E02D 3/026; B60B 7/04

(52) U.S. Cl. CPC E02D 3/0265; E02D 2300/0029; B60B 2900/212; B60B 7/04

(57) ABSTRACT

A wireguard subassembly includes a first circumferential segment defining a circumferential direction, a first near end, a first far end, and a first cleat portion disposed circumferentially between the first near end and the first far end; and a second circumferential segment defining a second near end, a second far end, and a second cleat portion disposed circumferentially between the second near end and the second far end. The second cleat portion is circumferentially aligned with the first cleat portion.

### TECHNICAL FIELD

The present disclosure relates to compactor wheels using to compact trash and debris in landfills, and the like. Specifically, the present disclosure relates to a wireguard with integrated cleats that may be attached to a compactor wheel to help prevent the fouling of an axle to which the compactor wheel is attached.

### BACKGROUND

A common problem with landfill compactors is trapping debris around the wheels. As the compactor continues to move, the debris moves and gets wrapped around the axles. This debris, if not removed, can damage axle assembly and can quickly degrade axle seals. This may necessitate maintenance and undesirable downtime for the compactor.

Various solutions have been previously developed to help prevent the fouling of the axle. For example, a wireguard may be employed that helps to prevent debris from entering the opening disposed between the compactor wheel and the axle.

U.S. Pat. No. 8,523,291 to Urgu discloses a tip for use with a wire guard system for a compactor wheel that includes a base portion and a wear portion attached to and extending from the base portion. A first groove is disposed at the wear portion and shaped to receive an end portion of a first wire guard section. A second groove is disposed at the wear portion and shaped to receive an end portion of a second wire guard section (see the Abstract of Urgu).

However, continuous improvement of such barriers so that they may be easily assembled and attached to the compactor wheel in a robust manner is warranted.

### SUMMARY

A compactor wheel assembly according to an embodiment of the present disclosure may comprise a hub portion including an axle attachment portion; a rim portion including an outer circumferential surface defining a radial direction, a circumferential direction, and a longitudinal axis; a plurality of cleats attached to the outer circumferential surface of the rim portion; and a wireguard attached to the rim, the wireguard extending circumferentially about the axle attachment portion being spaced radially away from the axle attachment portion and defining an outer diameter, a rear radially extending surface, and a front radially extending surface. The wireguard may be a subassembly including a first top member including a first material and a first cleat portion, and a first bottom member including a second material that is different than the first material and a second cleat portion contacting the first cleat portion.

A wireguard subassembly according to an embodiment of the present disclosure may comprise a first circumferential segment defining a proximate end including a ledge at least partially defining a notch; and a second circumferential segment defining a distal end disposed adjacent the proximate end of the first circumferential segment, the distal end including an overhang configured to mate with the ledge.

A wireguard subassembly according to another embodiment of the present disclosure may comprise a first circumferential segment defining a circumferential direction, a first near end, a first far end, and a first cleat portion disposed circumferentially between the first near end and the first far end; and a second circumferential segment defining a second near end, a second far end, and a second cleat portion disposed circumferentially between the second near end and the second far end. The second cleat portion may be circumferentially aligned with the first cleat portion and the second circumferential segment may include a void that is configured to hollow out at least partially the second cleat portion, the void forming a void undercut. The first circumferential segment includes a projection that at least partially fills the void undercut that is configured to prevent the separation of the first circumferential segment from the second circumferential segment.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a front oriented perspective view of a compactor wheel including a wireguard having integrated cleats according to an embodiment of the present disclosure.

FIG. 2 is a rear oriented perspective view of the compactor wheel of FIG. 1.

FIG. 3 is an enlarged detail view of the compactor wheel of FIG. 2 showing a first wireguard segment subassembly removed from the compactor wheel for enhanced clarity.

FIG. 4 is similar to FIG. 3 except that a second wireguard segment subassembly is shown mating with the first wireguard segment subassembly, preventing axial and radial movement of the first wireguard segment subassembly.

FIG. 5 is an exploded view of the first wireguard segment subassembly.

FIG. 6 is a perspective view illustrating another embodiment of a first wireguard segment subassembly according to principles of the present disclosure.

FIG. 7 is an exploded view of the first wireguard segment subassembly of FIG. 6.

FIG. 8 is an enlarged detail view of the top component of FIG. 7, showing the ball portions of the ball and socket joints used to join the first cleat portion to the second cleat portion.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of a compactor wheel assembly, and a wireguard subassembly according to various aspects of the present disclosure will now be described. In some embodiments, the various components are made from steel, allowing them to be durable and to be welded together. As will be discussed in more detail later herein, the wireguard subassembly may be comprised of eight 2-piece cast segments. The base casting may be of mild steel to promote ease of welding during assembly. The top casting may be cast over the base, thus mechanically interlocking the two cast components together. Other forms of attachment may be employed such as fastening the components together, etc. The top casting may be of a hard, wear resistant material. The segments may have a cleat formed into them that may aid in fore/aft traction. The segments, when assembled on the wheel, may interlock together to eliminate the need to weld the segments together in the radial direction (e.g. at the radial extending seam).

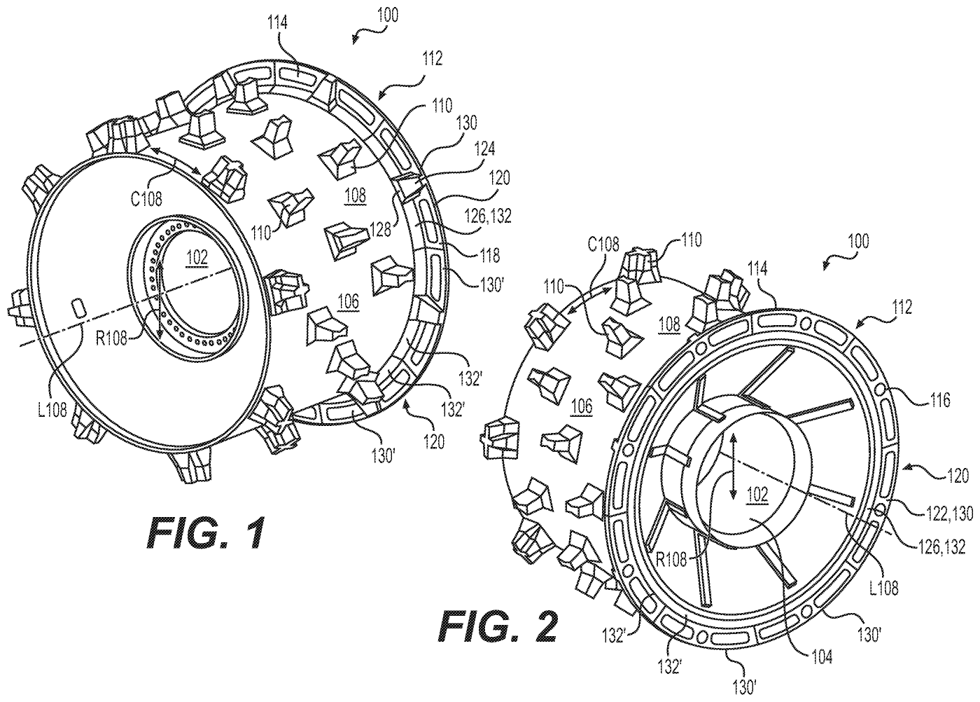

Looking at FIGS. 1 thru 5, a compactor wheel assembly 100 according to an embodiment of the present disclosure may comprise a hub portion 102 including an axle attachment portion 104, a rim portion 106 including an outer circumferential surface 108 defining a radial direction R108, a circumferential direction C108, and a longitudinal axis L108. A plurality of cleats 110 may be attached to the outer circumferential surface of the rim portion 106. Likewise, a wireguard 112 may be also attached to the rim portion 106. The wireguard 112 may extend circumferentially about the axle attachment portion 104 and may be spaced radially away from the axle attachment portion 104 and define an outer diameter 114. The wireguard 112 may further include a rear radially extending surface 116, and a front radially extending surface 118.

The wireguard 112 may be a subassembly 120 including a first top member 120 including a first material and a first cleat portion 124, and a first bottom member 126 including a second material that is different than the first material and a second cleat portion 128 contacting the first cleat portion 124.

In some embodiments, such as shown in FIGS. 1 thru 5, the first top member 122 is a first top circumferential member 130 (meaning it extends predominantly in the circumferential direction) and the first bottom member 126 is a first bottom circumferential member 132 (meaning it extends predominantly in the circumferential direction) contacting the first top circumferential member 130 circumferentially and axially.

More particularly, the subassembly 120 may further include a plurality of top circumferential members 130′ identical to and including the first top circumferential member 130 and a plurality of bottom circumferential members 132′ identical to and including the first bottom circumferential member 132. Eight of each may be provided. The number and configuration of these members may be varied as needed or desired in other embodiments to be different than what has been specifically shown or described herein. For example, some of the top circumferential members may be differently configured than others of the top circumferential members, and some of the bottom circumferential members may be differently configured than other of the bottom circumferential members.

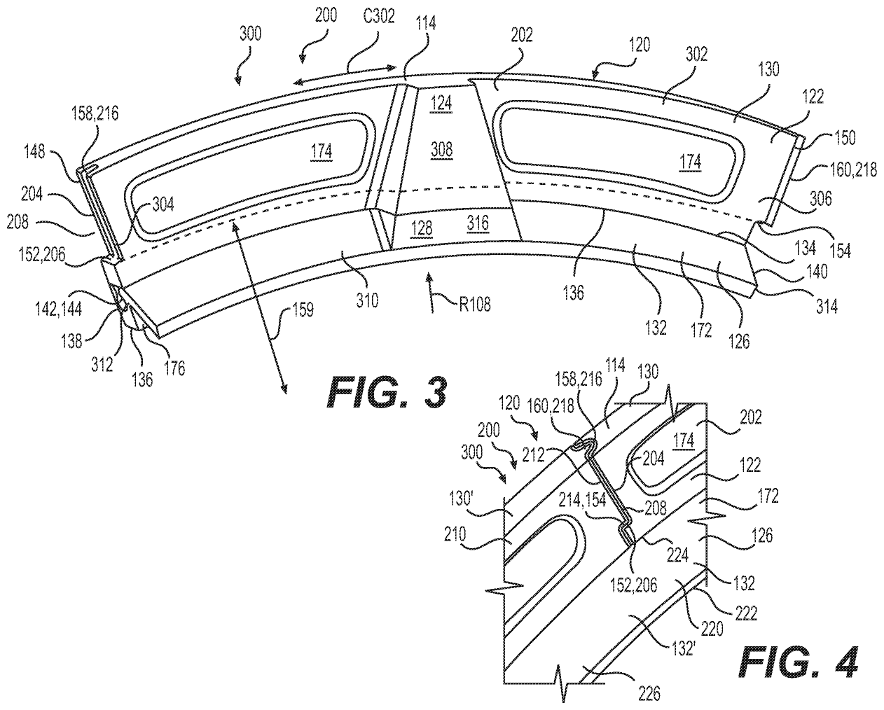

Focusing now on FIGS. 3 thru 5, the first bottom circumferential member 132 may include a top surface 134, a bottom surface 136, and defines a first circumferential end 138, a second circumferential end 140, and a circumferential slot 142 extending from the first circumferential end 138 to the second circumferential end 140. The circumferential slot 142 may define a first undercut 144 in the radial direction R108 and may extending radially to the top surface 134 of the first bottom circumferential member 132.

Similarly, the first top circumferential member 130 may define a bottom attachment surface 146, a third circumferential end 148 and a fourth circumferential end 150. The third circumferential end 148 may include a ledge 152 and the fourth circumferential end 150 may include an overhang 154. The first top circumferential member 130 may also include a tenon 156 extending from the third circumferential end 148 to the fourth circumferential end 150 configured to be held in the circumferential slot 142. The tenon 156 may be complimentarily shaped to the slot 142 as to be caught by the first undercut 144 so that the two components are held together along the radial direction R108. To that end, the tenon 156 and the slot 142 may have tear-drop shapes but other configurations are possible.

The ledge 152 may be disposed closer radially to the first bottom circumferential member 132 than the outer diameter 114 and may extend circumferentially and axially. At the same time, the third circumferential end 148 may also define a groove 158 extending radially from the ledge 152 to the outer diameter 114.

The overhang 154 may be disposed radially the same radial distance 159 from the longitudinal axis L108 as the ledge 152, and may extend circumferentially and axially. The fourth circumferential end 150 may further include a tongue 160 extending radially from the overhang 154 to the outer diameter 114. The tongue 160 and the groove 158 may be substantially v-shaped but other configurations are possible.

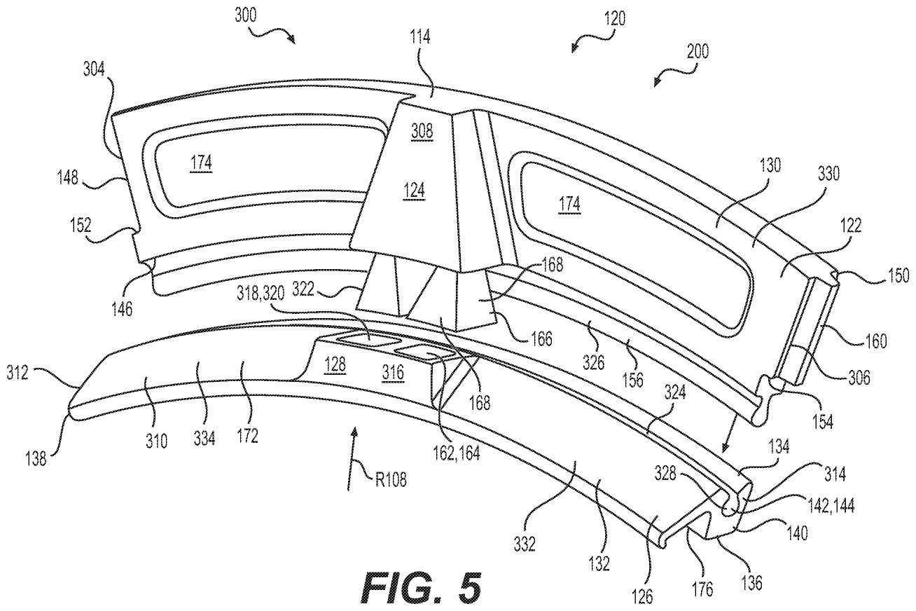

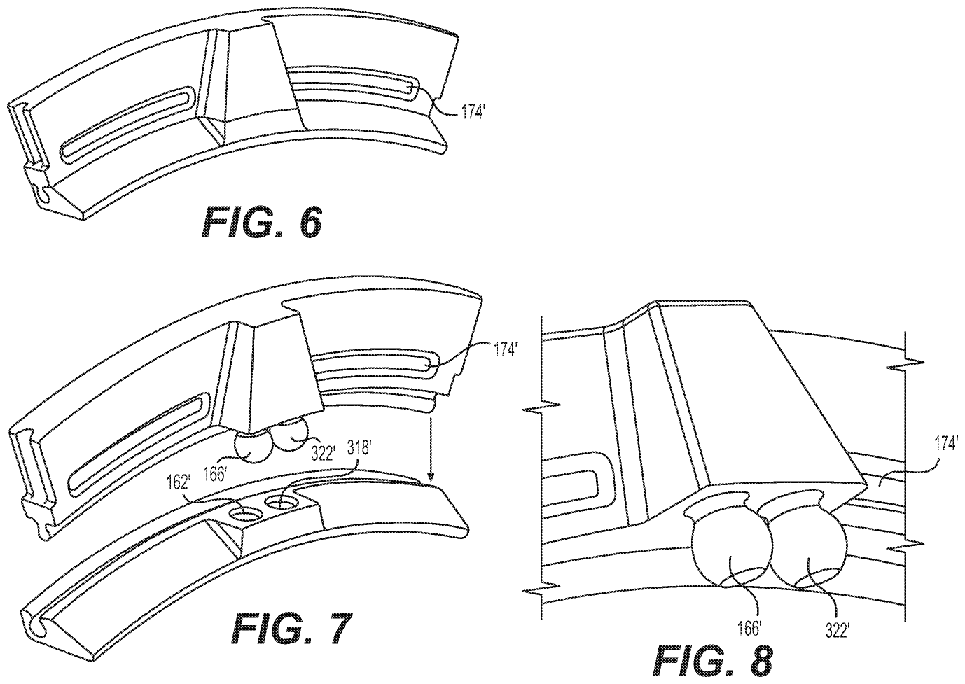

As best seen in FIG. 5, the first bottom circumferential member 132 may define an interior surface 162 that is disposed adjacent the second cleat portion 128. The interior surface 162 may extend to the top surface 134 and may define a second undercut 164 in the radial direction R108. The first top circumferential member 130 may include a protrusion 166 that is at least complimentarily shaped to the interior space 162, preventing movement along the radial direction R108. The protrusion 166 may include faceted surfaces 168 that prevent rotation of the components relative to each other. As indicated in FIG. 5, a pair of identically configured protrusions may be provided but not necessarily so.

Also, the first bottom member 126 may include an angled deflector portion 172 extending from the outer circumferential surface 108 of the rim portion 106 to the front radially extending surface 118 of the wireguard 112.

The various undercuts and protrusions that fill the undercuts may be created by casting one component to the other. In some embodiments, the bottom component is cast first and then the top component is cast onto it. In other embodiments, this process may be reversed. If so, then the features with undercuts and the features with protrusions may be switched from the bottom component to the top component, etc.

Since the components may be cast, recesses or voids may be provided to help maintain a fairly consistent nominal wall thickness to avoid problems such as porosity and voids. The various slots, voids, recesses, etc. may be partially designed for this purpose. Additional side recesses 174 may be provided on the top circumferential members to help maintain this desired wall thickness. Likewise a bottom recess 176 may be provided on the bottom circumferential members to maintain the desired wall thickness. Other variations of these features are possible.

A wireguard subassembly 200 according to an embodiment of the present disclosure may be described as follows focusing on FIGS. 3 thru 5. The subassembly 200 may comprise a first circumferential segment 202 defining a proximate end 204 including a ledge 206 at least partially defining a notch 208, and a second circumferential segment 210 defining a distal end 212 disposed adjacent the proximate end 204 of the first circumferential segment 202. The distal end 212 may include an overhang 214 configured to mate with the ledge 206. The proximate end 204 may define a radially extending groove 216 and the distal end 212 may include a radially extending tongue 218 disposed in the radially extending groove 216. These features may prevent axial movement of the components.

As best seen in FIG. 4, the wireguard subassembly 200 may further comprising a third circumferential segment 220 attached to the first circumferential segment 202 via casting, fastening, welding, etc. The third circumferential segment 220 may include a bottom attachment surface 222 and a top abutment surface 224 contacting the first circumferential segment 202. The wireguard subassembly may further comprise a fourth circumferential segment 226 that may be identically configured as the third circumferential segment 220. The fourth circumferential segment 226 may be attached to the second circumferential segment 210 via casting, fastening, welding, etc.

Also, the first circumferential segment 202 may be identically configured as the second circumferential segment 210. As alluded to earlier herein, the third circumferential segment 210 may be cast first and the first circumferential segment 202 may be cast onto the third circumferential segment 230 to form at least a portion of the subassembly 200. A portion of the subassembly may be formed with this order reversed in other embodiments.

The first circumferential segment 202 may include material properties and the second circumferential segment 210 may include material properties that are the same as the first circumferential segment 202. This similarity may continue completely around the circumference of the subassembly 200 for all of the top components. For example, the material properties may include a material, a coating, a hardness, etc. that may be well-suited for prolonging the wear of the components.

In like fashion, the third circumferential segment 220 includes material properties and the fourth circumferential segment 226 includes material properties that are the same as the third circumferential segment 220. For example, the material properties may include a material, a coating, a hardness, etc. that is different than that of the top components so that the bottom components may be welded better to the rim portion of the compactor wheel.

More specifically, the first and the second circumferential segments 202, 210 may include high chrome white iron and the third and the fourth circumferential segments 220, 226 may include mild steel. Other materials may be employed.

A wireguard subassembly 300 according to another embodiment of the present disclosure may be described as follows referring to FIGS. 3 thru 5. The subassembly 300 may comprise a first circumferential segment 302 defining a circumferential direction C302, a first near end 304, a first far end 306, and a first cleat portion 308 disposed circumferentially between the first near end 304 and the first far end 306. The subassembly 300 may further comprise a second circumferential segment 310 defining a second near end 312, a second far end 314, and a second cleat portion 316 disposed circumferentially between the second near end 312 and the second far end 314.

As best seen in FIG. 5, the second cleat portion 316 may be circumferentially aligned with the first cleat portion 308 and the second circumferential segment 310 may include a void 318 that is configured to hollow out at least partially the second cleat portion 316. The void 318 may form a void undercut 320. In addition, and the first circumferential segment 302 may include a projection 322 that at least partially fills the void undercut 320 that is configured to prevent the separation of the first circumferential segment 302 from the second circumferential segment 310.

The second circumferential segment 310 may further define a circumferentially extending slot 324 that extends from the second near end 312 to the second far end 314. The first circumferential segment 302 may further include a circumferentially extending projection 326 that extends from the first near end 304 to the first far end 306 and that is disposed in the circumferentially extending slot 324 (see FIG. 3).

Looking at FIGS. 3 and 5 together, the circumferentially extending slot 324 may form a slot undercut 328. The circumferentially extending projection 326 may at least partially fill the slot undercut 328 that is configured to prevent the separation of the first circumferential segment 302 from the second circumferential segment 310.

As alluded to earlier herein, the first circumferential segment 302 may be a top segment 330, while the second circumferential segment 310 may be a bottom segment 332. Also, the bottom segment 332 may include an angled ramp 334 and the second cleat portion 316 may extend from the angled ramp 334.

Referring now to FIGS. 6 thru 7, other embodiments of a wireguard subassembly identical to those of FIGS. 3 thru 5 except for the following differences will now be discussed. The projection 322′ or protrusion 166′ and associated void 318′ or interior surface 162′ are now form a ball and socket joint (a pair may be provided). The bottom recess 176 has been eliminated and the side recesses 174′ have been diminished in size, creating a thicker nominal wall thickness. The solid base casting and ball and socket designs may improve fatigue performance and the casting process.

Any of the configurations, materials, material properties, and dimensions mentioned herein may be altered in various embodiments of the present disclosure to have different values or characteristics than what has been specifically mentioned herein or shown in the drawings.

### INDUSTRIAL APPLICABILITY

In practice, a compactor wheel assembly, a wireguard subassembly, and/or various components of the wireguard subassembly according to any embodiment described herein may be sold, bought, manufactured or otherwise obtained in an OEM (original equipment manufacturer) or after-market context.

In various embodiments, the white iron content of the top casting may range from 6 to 7 million mm³ while the mild steel content of the bottom casting may range 2.5 to 3.5 million mm³. The type of content and the amount may be adjusted as needed or desired in other embodiments.

Various assembly techniques or methods may be employed for creating the compactor wheel assembly and the wireguard subassembly according to various embodiments of the present disclosure.

For example, a pair of top and bottom components of the wireguard subassembly may be assembled together in various ways such as being dove tailed or pinned together and then fastened, cast together, etc. Then, the bottom component may be welded to the rim portion of the compactor wheel assembly. Additional pairs of top and bottom components may then mated with an adjacent pair of top and bottom components with the newly added supplied component being welded or otherwise attached to the rim portion of the compactor wheel assembly. This mating may eliminate the need for a weld between adjacent pairs of the top and the bottom components. This process may be repeated about the circumference of the rim portion until the wireguard is complete.

The subassembly may be sold or otherwise provided as a kit containing a plurality of pairs of the top and bottom components to be added to the compactor wheel assembly in the field. The compactor wheel assembly may be sold with the wireguard already installed, etc.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A compactor wheel assembly comprising:
a hub portion including an axle attachment portion;
a rim portion including an outer circumferential surface defining a radial direction, a circumferential direction, and a longitudinal axis;
a plurality of cleats attached to the outer circumferential surface of the rim portion; and
a wireguard attached to the rim, the wireguard extending circumferentially about the axle attachment portion being spaced radially away from the axle attachment portion and defining an outer diameter, a rear radially extending surface, and a front radially extending surface;
wherein the wireguard is a subassembly including a first top member including a first material and a first cleat portion, and a first bottom member including a second material that is different than the first material and a second cleat portion contacting the first cleat portion.

2. The compactor wheel assembly of claim 1 wherein the first top member is a first top circumferential member and the first bottom member is a first bottom circumferential member contacting the first top circumferential member circumferentially and axially.

3. The compactor wheel assembly of claim 2 wherein the subassembly further includes a plurality of top circumferential members identical to and including the first top circumferential member and a plurality of bottom circumferential members identical to and including the first bottom circumferential member.

4. The compactor wheel assembly of claim 3 wherein the first bottom circumferential member includes a top surface, a bottom surface, and defines a first circumferential end, a second circumferential end, and a circumferential slot extending from the first circumferential end to the second circumferential end and defining a first undercut in the radial direction, the circumferential slot also extending radially to the top surface of the first bottom circumferential member.

5. The compactor wheel assembly of claim 4 wherein the first top circumferential member defines a bottom attachment surface, a third circumferential end and a fourth circumferential end, and the third circumferential end includes a ledge and the fourth circumferential end includes an overhang, the first top circumferential member also including a tenon extending from the third circumferential end to the fourth circumferential end configured to be held in the circumferential slot.

6. The compactor wheel assembly of claim 5 wherein the ledge is disposed closer radially to the first bottom circumferential member than the outer diameter, the ledge extending circumferentially and axially, the third circumferential end also defining a groove extending radially from the ledge to the outer diameter.

7. The compactor wheel assembly of claim 6 wherein the overhang is disposed radially the same radial distance from the longitudinal axis as the ledge, the overhang extending circumferentially and axially, the fourth circumferential end further including a tongue extending radially from the overhang to the outer diameter.

8. The compactor wheel assembly of claim 4 wherein the first bottom circumferential member defines an interior surface that is disposed adjacent the second cleat portion, the interior surface extending to the top surface and defining a second undercut in the radial direction.

9. The compactor wheel assembly of claim 1 wherein the first bottom member includes an angled deflector portion extending from the outer circumferential surface of the rim portion to the front radially extending surface of the wireguard.

10. A wireguard subassembly comprising:
a first circumferential segment defining a proximate end including a ledge at least partially defining a notch; and
a second circumferential segment defining a distal end disposed adjacent the proximate end of the first circumferential segment, the distal end including an overhang configured to mate with the ledge.

11. The wireguard subassembly of claim 10 wherein the proximate end defines a radially extending groove and the distal end includes a radially extending tongue disposed in the radially extending groove.

12. The wireguard subassembly of claim 10 further comprising a third circumferential segment attached to the first circumferential segment, the third circumferential segment including a bottom attachment surface and a top abutment surface contacting the first circumferential segment, and a fourth circumferential segment, wherein the fourth circumferential segment is identically configured as the third circumferential segment and is attached to the second circumferential segment, and the first circumferential segment is identically configured as the second circumferential segment.

13. The wireguard subassembly of claim 12 wherein the first circumferential segment includes material properties and the second circumferential segment includes material properties that are the same as the first circumferential segment.

14. The wireguard subassembly of claim 13 wherein the third circumferential segment includes material properties and the fourth circumferential segment includes material properties that are the same as the third circumferential segment.

15. The wireguard subassembly of claim 10 wherein the first and the second circumferential segments include high chrome white iron and the third and the fourth circumferential segments include mild steel.

16. The wireguard subassembly of claim 10 wherein the first and the third circumferential segments are cast to form at least a portion of the subassembly.

17. A wireguard subassembly comprising:
a first circumferential segment defining a circumferential direction, a first near end, a first far end, and a first cleat portion disposed circumferentially between the first near end and the first far end; and
a second circumferential segment defining a second near end, a second far end, and a second cleat portion disposed circumferentially between the second near end and the second far end;
wherein the second cleat portion is circumferentially aligned with the first cleat portion and the second circumferential segment includes a void that is configured to hollow out at least partially the second cleat portion, the void forming a void undercut, and the first circumferential segment includes a projection that at least partially fills the void undercut that is configured to prevent the separation of the first circumferential segment from the second circumferential segment.

18. The wireguard subassembly of claim 17 wherein the second circumferential segment further defines a circumferentially extending slot that extends from the second near end to the second far end and the first circumferential segment further includes a circumferentially extending projection that extends from the first near end to the first far end and that is disposed in the circumferentially extending slot.

19. The wireguard subassembly of claim 18 wherein the circumferentially extending slot forms a slot undercut and the circumferentially extending projection at least partially fills the slot undercut that is configured to prevent the separation of the first circumferential segment from the second circumferential segment.

20. The wireguard subassembly of claim 17 wherein the first circumferential segment is a top segment, the second circumferential segment is a bottom segment, and the bottom segment includes an angled ramp and the second cleat portion extends from the angled ramp.
